(19) United States
(12) Patent Application Publication
(10) Pub. No.: US 2020/0121962 A1
(43) Pub. Date: Apr. 23, 2020

(54) SAFER BELAY DEVICE

(71) Applicant: Victor Saunders, Les Houches (FR)

(72) Inventor: Victor Saunders, Les Houches (FR)

(21) Appl. No.: 16/659,205

(22) Filed: Oct. 21, 2019

Related U.S. Application Data
(60) Provisional application No. 62/749,593, filed on Oct. 23, 2018.

(51) Int. Cl. A62B 1/14

(52) U.S. Cl. CPC A62B 1/14

(57) ABSTRACT

The invention is an improvement on a wired belay device, having the wire attached eccentrically to the device, allowing the device to be device to be retained in the karabiner throughout the process of installing the ropes.

### RELATIONSHIP TO OTHER APPLICATIONS

None

### FIELD OF THE INVENTION

The invention related to belay devices used in rope-assisted climbing

### BACKGROUND

A belay device acts as a brake on the climbing rope. The belay device comprises a frame with one or more apertures and a closed loop attached thereto. In use, the rope is looped through the belay device with the climber on one (distal) end and the belayer on the other (proximal) end. The belayer's braking hand holds the free end of the rope and is used to lock off the rope by pulling it down taught, halting the decent of the climber attached to the climbing end. The belay device is an essential device for climbing safety. The term “ATC” or Air Traffic Controller is sometimes used to describe a type of belay device.

Belay devices act as a friction brake, so that when a climber falls with any slack in the rope, the fall is brought to a stop. Typically, when the rope is held outward, away from the body, it moves relatively freely, so the belayer can take up or pay out slack. When the rope is brought backward, to the side of the body, the rope is forced into tight bends and rubs against the device and/or against itself, allowing the belayer to arrest the descent of a climber in the case of a fall. This rubbing slows the rope, but also generates heat. Some types of belay devices can arrest a fall without the belayer taking any action, while others require the belayer to hold or pull the rope in a particular direction. Belay devices usually attach to the harness of the belayer via a carabiner, and are usually made of aluminium or an alloy. Tubular and Assisted-braking belay devices have a central wire which clips in the main carabiner. There are many examples. See https://tinyurl.com/ydf6m4o7. Some belay devices can also be used as descenders for a controlled descent on a rope (abseiling). For example, “FIG. 8” device is primarily used for rappelling, however, they can be rigged to belay a leader or a top-rope climber.

There are three primary types of belay device: Tubular, Assisted Braking, and FIG. 8.

Tubular Belay Devices are very common. They have one or two apertures (slots) through which a rope may be passed, and a wire or cable attached in a closed loop attached at either end to the device. A single slot belay device may be used for techniques requiring only one rope to pass through the device. The double-slot design allows a user to feed single or double ropes through the device without kinking the rope. In use, the rope is folded and pushed through an aperture (slot) of the device and clipped with a locking carabiner to the belayer or directly to the anchor. Friction caused by the bent rope's contact with the belay device slows down and stops the rope, helping to protect the climber. The dual slots found on nearly every tubular device accept two strands of rope for standard rappelling technique.

Assisted-braking belay devices (also called self-braking, self-locking, auto-blocking or auto-locking devices) use an internal camming mechanism designed to automatically lock down on the rope when a sudden force is applied to it to help the belayer catch and hold a fall.

FIG. 8 devices are primarily used for rappelling; however, they can be rigged to belay a leader or a top-rope climber. Shaped like the number eight, they have one larger and one smaller hole. When rappelling, you feed a bight (bend) of rope through the large hole and loop it around the outside of the small hole till it rests on the “neck” of the FIG. 8. The small hole is clipped to your belay loop on your harness. FIG. 8s are frequently used for search and rescue, caving and rappelling

A major and long-felt problem with belay devices is that the belay device must be unclipped from the karabiner in order to feed the ropes in to the system. Unclipping leads to risk, and to the possibility of the belay device being dropped, especially in cold wet conditions or where the climber is wearing gloves. There is clearly a need for a wired belay device that addresses this problem.

### BRIEF DESCRIPTION OF THE INVENTION

The invention encompasses an improvement to traditional tubular belay devices, whereby the retaining wire is positioned and securely fixed asymmetrically to one side.

### BRIEF DESCRIPTION OF THE FIGURES

FIG. 1 Shows the belay device of the invention. 1=Frame. 2=First rope slot. 3=Second rope slot. 4=Wire attached to the frame at both ends so that the line drawn between the two points of attachment is parallel to the long axis of the slots, and so that the wire is set eccentrically to one side of the two slots.

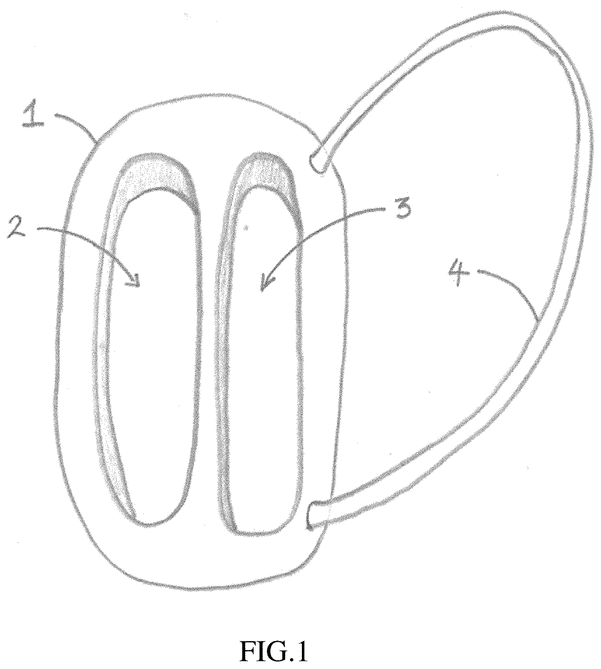

FIG. 2 Shows a traditional belay device. 1=Frame. 2=First rope slot. 3=Second rope slot. 4=Wire attached centrally so that the line drawn between the two points of attachment runs between the two slots.

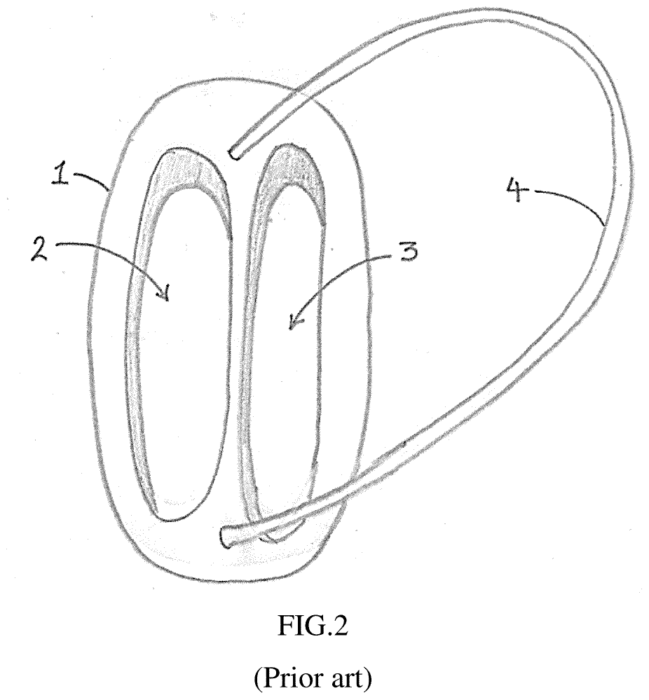

FIG. 3 Shown a belay device in use. 1=Frame. 2=First rope slot. 3=Second rope slot. 4=Wire. 5=rope. 6=carabiner. 7=climber end f rope. 8=belayer/braking end of rope.

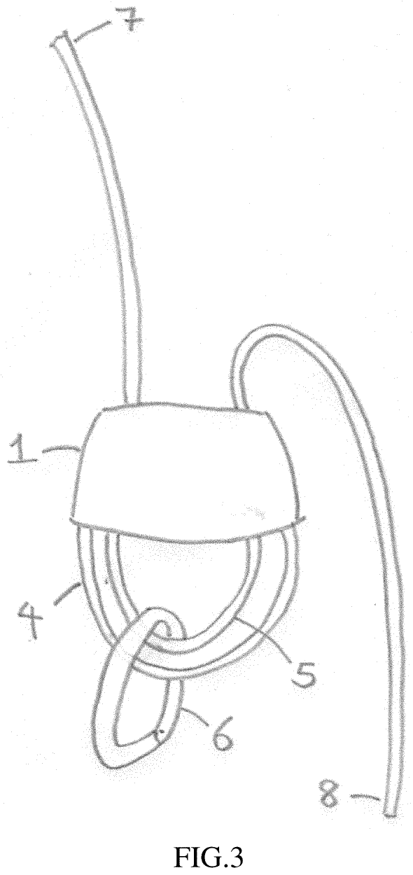

### DETAILED DESCRIPTION OF THE INVENTION

The problem with typical belay devices is that the belay device must be unclipped from the carabiner in order to feed the ropes in to the system. This leads to risk and the possibility of dropping the unclipped belay device, where the belayer is wearing gloves.

The invention is an improvement on a standard tubular double-slot wired belay device, having the wire attached eccentrically to the device, with both attachment points on the same side of the frame, parallel to the slots. Specifically, the wire is attached to the frame at both ends so that the line drawn between the two points of attachment is parallel to the long axis of the slots, and so that the wire is set eccentrically to one side of the two slots. The wire is not set diagonally across the slots, nor in any other orientation except as described. This enables ropes to be fed into the slots without unclipping the belay device.

Essentially the invention is constructed by providing a wired double-slot belay device and by permanently fixing the retaining wire asymmetrically to one side of the slots. This allows the belay device to be retained in the carabiner throughout the process of installing the ropes. This is useful because the belay device cannot be dropped in this system. This is especially important in winter and alpine settings where the belayer is wearing gloves or mitts.

### EXAMPLES

A belay device comprising an approximately rectangular-tubular-shaped frame made from a single contiguous form with a top side and a bottom side. The frame has disposed there-through at least two slots, each of an approximately rectangular shape, with rounded interior edges, disposed side-by-side with the long sides parallel, wherein at least some part of each slot on the top side includes a rough, uneven or bevelled surface (“breaking grooves”) to enhance rope friction while in use. The frame is adapted so that a rope may be bent and a “bite” of rope inserted into one of the slots. Further, the frame has permanently and securely affixed thereto, on the bottom side, a cable (a wire) having a first end and a second end, that forms a closed loop, each of which ends are attached to the frame at a first attachment point and a second attachment point respectively. Both attachments are disposed to one side of the form, with both slots disposed to a one side of the wire, and wherein the wire is not positioned between the two apertures or diagonally across the slots.

The frame is generally made of aluminium or a metal alloy.

The wire is usually made of nylon-coated steel cable. Note that the term “wire” does not limit the substance to any particular form, cross-sectional shape or substance, but may be any means that can be used to provide a closed loop in the present application. The wire is usually of a flexible material but in other embodiments may be made of a rigid material.

1. A belay device comprising a single contiguous frame having a top side and a bottom side, and at least two apertures disposed thererthrough, positioned side-by-side within the frame adapted to receive a rope, and further, having permanently and securely affixed to the bottom side, a wire having a first end and a second end, both of which ends are attached to the frame so as to form a closed loop, wherein both attachments are disposed to one side of the form, with both slots disposed to the same side of the wire.

2. The belay device of claim 1 wherein the wire is not positioned between or across the two apertures.

3. The belay device of claim 2 wherein the wire is a nylon-coated steel cable.
